(19) United States
(12) Patent Application Publication
(10) Pub. No.: US 2021/0402977 A1
(43) Pub. Date: Dec. 30, 2021

(54) SYSTEM AND METHOD FOR CONTROLLING TRACTION FORCE OF ELECTRIFIED VEHICLE

(71) Applicants: Hyundai Motor Company, Seoul (KR); Kia Motors Corporation, Seoul (KR)

(72) Inventors: Sang Joon Kim, Seoul (KR); Sung Hoon Yu, Hwaseong (KR)

(21) Appl. No.: 17/106,517

(22) Filed: Nov. 30, 2020

(30) Foreign Application Priority Data
Jun. 26, 2020 (KR) 10-2020-0078292

(51) Int. Cl. B60W 20/15; B60W 10/08; B60W 40/06

(52) U.S. Cl. CPC B60W 20/15; B60W 10/08; B60W 2050/0037; B60W 2710/085; B60W 2510/083; B60W 40/06

(57) ABSTRACT

A system and a method are configured to control a traction force of a vehicle, for example, an electrified vehicle. The system includes wheel speed sensors mounted on drive wheels, respectively, of the vehicle to measure a drive wheel speed, a disturbance observer for extracting a primary disturbance by comparing an actual vehicle behavior based on a required torque with a vehicle behavior estimated based on the drive wheel speed using a vehicle behavior model in an acceleration situation of the vehicle, a filter for extracting a secondary disturbance in a preset frequency range from the primary disturbance, a compensator for calculating a compensation torque for cancelling the secondary disturbance, a hysteresis circuit for determining whether to compensate for the required torque based on the compensation torque, and a calculator for calculating a compensated required torque using the required torque and the compensation torque.

### CROSS-REFERENCE TO RELATED APPLICATION

This application claims under 35 U.S.C. § 119(a) the benefit of Korean Patent Application No. 10-2020-0078292, filed in the Korean Intellectual Property Office on Jun. 26, 2020, the entire contents of which are incorporated herein by reference.

### BACKGROUND

### (a) Technical Field

The present disclosure relates to a system and a method for controlling a traction force of a vehicle, for example, an electrified vehicle.

### (b) Description of the Related Art

In general, a traction control system (TCS) applied to a vehicle can prevent slip of a drive wheel, maximize a traction force of the drive wheel to secure safe travel on a slippery road surface, and improve acceleration performance on a high friction road surface. Typically, a speed target value of the drive wheel may be set based on a vehicle speed so as to control the drive wheel to follow the set target value for controlling a traction force of a two-wheel drive vehicle. In such a traction force control method, it is common to perform the control by replacing a speed of a driven wheel as the vehicle speed.

When controlling a traction force of a four-wheel drive vehicle, there may be a case in which the speed of the driven wheel is not used unlike the case of the two-wheel drive vehicle, so that a separate sensor may be used to estimate the vehicle speed. However, in this case, there is an increase in material cost, which is disadvantageous in terms of mass production. In one example, the vehicle speed may be estimated using artificial intelligence technology such as fuzzy, but there is a disadvantage in terms of a calculation overhead.

Accordingly, a technology for controlling a wheel slip using a model-based methodology without estimating the vehicle speed has been proposed. This model-based traction force control technology selects a nominal model, compares an actual revolution per minute of the drive wheel based on a torque applied to a powertrain with a revolution per minute output from the nominal model when such torque is applied to the nominal model to recognize a revolution per minute difference therebetween as a disturbance, and compensates for a powertrain torque command taking into account the recognized disturbance. In the case of such model-based traction force control technology, all differences between nominal model-based vehicle behavior and actual vehicle behavior are viewed as the disturbance and are compensated for. Thus, when continuously controlling the traction force, there is a problem that the control works sensitively, and unnecessary components may be included in the observed disturbance, which results in deterioration of a control performance.

As such, there are cost and technical problems in the speed estimation when controlling the traction force based on the actual vehicle speed, and the existing model-based control has a problem of being vulnerable to noise.

### SUMMARY

An aspect of the present disclosure provides a system and a method for controlling a traction force of an electrified vehicle capable of stably controlling a wheel slip regardless of a travel situation.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for controlling a traction force of a vehicle (e.g., an electrified vehicle) includes: wheel speed sensors mounted on a plurality of drive wheels, respectively, of the vehicle to measure a drive wheel speed, a disturbance observer for extracting a primary disturbance by comparing an actual vehicle behavior based on a required torque with a vehicle behavior estimated based on the drive wheel speed using a vehicle behavior model in an acceleration situation of the vehicle, a filter for extracting a secondary disturbance in a preset frequency range from the primary disturbance, a compensator for calculating a compensation torque for cancelling the secondary disturbance, a hysteresis circuit for determining whether to compensate for the required torque based on the compensation torque, and a calculator for calculating a compensated required torque using the required torque and the compensation torque.

In one implementation, a nominal model or an inverse nominal model may be used as the vehicle behavior model.

In one implementation, the filter may include at least one of a low pass filter, a high pass filter, or a band pass filter.

In one implementation, the compensator may set a gain based on a road surface inclination when calculating the compensation torque.

In one implementation, the hysteresis circuit may determine to activate torque compensation control when the compensation torque exceeds a first reference torque.

The hysteresis circuit may determine to deactivate torque compensation control when the compensation torque is less than or equal to a second reference torque.

In one implementation, the system may further include a rate limiter for limiting a rate of change of the compensation torque when compensating for the required torque.

In one implementation, the rate limiter may set a rate of change in increase of the compensation torque to a single value in consideration of response characteristics of a motor.

In one implementation, the rate limiter may set a rate of change in decrease of the compensation torque based on at least one of a road surface inclination or a gear step.

In one implementation, the system may further include a power distributor for controlling the vehicle behavior by distributing the compensated required torque to a motor and an engine, and the power distributor may preferentially distribute the compensated required torque to the motor.

According to another aspect of the present disclosure, a method for controlling a traction force of an electrified vehicle includes: detecting, by drive wheel sensors, a drive wheel speed based on a required torque in an acceleration situation of the vehicle; extracting, by a disturbance observer, a primary disturbance by comparing a vehicle behavior estimated based on the drive wheel speed using a vehicle behavior model with an actual vehicle behavior based on the required torque; extracting, by a filter, a secondary disturbance in a preset frequency range from the primary disturbance; calculating, by a compensator, a compensation torque for cancelling the secondary disturbance; determining, by a hysteresis circuit, whether to compensate for the required torque based on the compensation torque; and compensating, by a calculator, for the required torque by reflecting the compensation torque.

In one implementation, the extracting of the primary disturbance may include extracting the primary disturbance using a nominal model or an inverse nominal model as the vehicle behavior model.

In one implementation, the extracting of the secondary disturbance may include filtering the secondary disturbance from the primary disturbance using at least one of a low pass filter, a high pass filter, or a band pass filter.

In one implementation, the calculating of the compensation torque may include setting a gain based on a road surface inclination when calculating the compensation torque.

In one implementation, the determining of whether to compensate for the required torque may include determining to activate torque compensation control when the compensation torque exceeds a first reference torque.

In one implementation, the determining of whether to compensate for the required torque may include determining to deactivate torque compensation control when the compensation torque is less than or equal to a second reference torque.

In one implementation, the method may further include limiting a rate of change of the compensation torque when compensating for the required torque.

In one implementation, the limiting of the rate of change of the compensation torque may include setting a rate of change in increase of the compensation torque to a single value in consideration of response characteristics of a motor.

In one implementation, the limiting of the rate of change of the compensation torque may include setting a rate of change in decrease of the compensation torque based on at least one of a road surface inclination or a gear step.

In one implementation, the method may further include controlling the vehicle behavior by distributing the compensated required torque to a motor and an engine, and the compensated required torque may be preferentially distributed to the motor.

### BRIEF DESCRIPTION OF THE DRAWINGS

The above and other objects, features and advantages of the present disclosure will be more apparent from the following detailed description taken in conjunction with the accompanying drawings:

FIG. 1 is a configuration diagram illustrating an electrified vehicle associated with the present disclosure;

FIG. 2 is a functional block diagram illustrating a traction control system of an electrified vehicle according to an embodiment of the present disclosure;

FIG. 3 is another example illustrating a configuration of a disturbance observer according to an embodiment of the present disclosure;

FIG. 4 is a graph illustrating a traction force of a vehicle based on a slip ratio associated with the present disclosure;

FIG. 5 shows a configuration diagram of the filter illustrated in FIG. 2;

FIG. 6 is a flowchart illustrating a method for controlling a traction force of an electrified vehicle according to an embodiment of the present disclosure;

FIGS. 7 to 9 are views for describing a wheel slip control performance based on traction force control of an electrified vehicle according to an embodiment of the present disclosure; and

FIG. 10 illustrates a computing system in which a method for controlling a traction force of an electrified vehicle according to an embodiment of the present disclosure is implemented.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

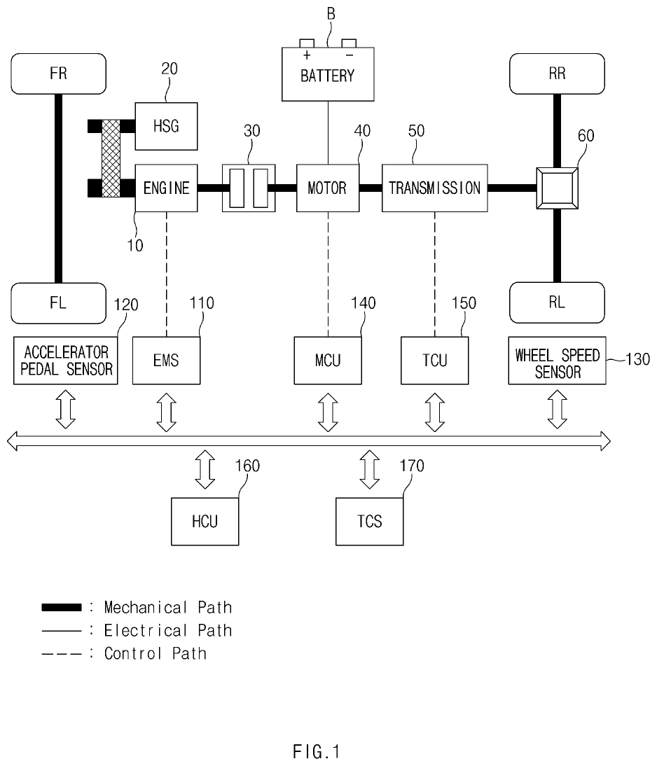

FIG. 1 is a configuration diagram illustrating an electrified vehicle associated with the present disclosure.

Referring to FIG. 1, an electrified vehicle includes an engine 10, a hybrid starter generator (HSG) 20, an engine clutch 30, a motor 40, a transmission 50, a differential gear 60, an engine management system (hereinafter, EMS) 110, an accelerator pedal sensor (APS) 120, a wheel speed sensor 130, a motor control unit (hereinafter, MCU) 140, a transmission control unit (hereinafter, TCU) 150, a hybrid control unit (hereinafter, HCU) 160, and a traction control system (hereinafter, TCS) 170.

The engine 10 generates power (i.e., an engine torque) required for driving a vehicle by burning fuel. As the engine 10, various known engines such as a gasoline engine, a diesel engine, or the like may be used. The engine 10 controls an output torque (that is, the engine torque) in response to a command of the EMS 110.

The HSG 20 may be mounted on the engine 10 to start the engine 10 by cranking the engine 10. The HSG 20 may generate electric energy by operating as a generator in the state in which the engine 10 is started. The electric energy generated by the HSG 20 may be used to charge a battery B.

The engine clutch 30 is disposed between the engine 10 and the motor 40 to regulate the power (i.e., the output torque) of the engine 10. The engine clutch 30 may transmit the power (i.e., the engine torque) generated by the engine 10 to drive wheels RR and RL or block the power (i.e., the engine torque) through engagement or disengagement.

The motor 40 receives electric power from the battery B to generate power (i.e., motor power) and transmits the generated power to the drive wheels RR and RL. The motor 40 controls an output torque (i.e., a motor torque) by changing a rotation direction and a revolution per minute (RPM) in response to a command of the MCU 140. The motor 40 may be used as a generator for charging the battery B by generating a counter electro-motive force when a state of charge (SOC) is insufficient or during regenerative breaking. The battery B, which serves to supply the electric power required to drive the vehicle, is implemented as a high voltage battery. A power converter (not shown) may be disposed between the motor 40 and the battery B. The power converter (not shown) converts a voltage output from a vehicle battery (not shown) to a motor driving voltage and supplies the motor driving voltage. The battery B may be charged by regenerative energy generated by the motor 40.

The transmission 50 converts the motor torque, or the engine torque and the motor torque with a gear ratio that matches a gear step and outputs the converted motor torque, or engine torque and motor torque. The transmission 50 changes the gear step in response to a command of the TCU 150.

The differential gear 60 transmits a driving torque output from the transmission 50 to the drive wheels RR and RL. The differential gear 60 distributes the power generated by the engine 10 and/or motor 40 to both the drive wheels RR and RL.

The EMS 110 controls overall operation of the engine 10. The EMS 110 may control a rotational speed and/or the output torque (the engine torque) of the engine 10. The EMS 110 transmits a target engine torque and/or an actual engine torque to the HCU 160. The target engine torque may be provided by the TCU 150 or may be determined by the EMS 110. The actual engine torque may be calculated using an engine rotational speed measured by a sensor.

The accelerator pedal sensor 120 detects a location of the accelerator pedal. The accelerator pedal sensor 120 converts a degree at which a driver presses the accelerator pedal (i.e., a stepped amount or a pressing amount) into an electrical signal (e.g., a voltage) and outputs the electrical signal.

Each wheel speed sensor 130 (of a plurality of wheel sensors 130 corresponding to wheels FR, FL, RR, and RL, respectively) is installed on each wheel to measure a wheel speed. For example, each wheel speed sensor 130 may be mounted on each wheel FR, FL, RR, or RL to measure a revolution per minute of each wheel FR, FL, RR, or RL.

The MCU 140 controls the output torque of the motor 40 in response to a command of the HCU 160. In other words, the MCU 140 may receive a target motor torque from the HCU 160 as the command and control a rotational speed and/or a rotational direction of the motor 40 in response to the received command.

The TCU 150 controls overall operation of the transmission 50. The TCU 150 may determine an optimal gear step based on information such as a travel speed of the vehicle (that is, a vehicle speed), the accelerator pedal position, an engine revolution per minute and/or clutch travel through sensors in the vehicle. TCU 150 controls a gear actuator based on the determined gear step information to perform a speed changing procedure.

The HCU 160 may be connected to the EMS 110, the accelerator pedal sensor 120, the wheel speed sensor 130, the MCU 140, the TCU 150, and the TCS 170 through a vehicle network. The vehicle network is implemented as a controller area network (CAN), a media oriented system transport (MOST) network, a local interconnect network (LN), an ethernet, and/or an X-by-Wire (Flexray).

The HCU 160 may recognize a travel situation (e.g., an acceleration situation, or when the vehicle is accelerating) of the vehicle and control a vehicle behavior through each of the control devices 110, 140, 150 and/or 170 based on the travel situation. The HCU 160 may calculate a driver-required-torque based on the accelerator pedal position information obtained using the accelerator pedal sensor 120. The HCU 160 may transmit the driver-required-torque to the TCS 170 when the TCS 170 is operating. For example, the HCU 160 activates the TCS 170 when sensing a speed difference between the wheels by comparing the wheel speeds through the wheel speed sensors 130 respectively mounted on the wheels FR, FL, RR, and RL when accelerating the vehicle. The HCU 160 may provide the driver-required-torque to the TCS 170 while the TCS 170 is operating.

The TCS 170 controls a traction force (or a driving force) of the drive wheels RR and RL based on a torque required for driving the vehicle (i.e., a required torque) in a situation in which the vehicle is accelerated (that is, the acceleration situation). The TCS 170 estimates a disturbance affecting the vehicle behavior when the vehicle behaves based on the required torque by the driver (or a target torque of a powertrain), and compensates for the required torque such that the estimated disturbance is canceled. The TCS 170 may transmit an engine torque command and a motor torque command to the EMS 110 and the MCU 140, respectively, based on the compensated required torque. The EMS 110 and the MCU 140 may respectively adjust the engine torque and the motor torque based on the commands of the TCS 170.

Each of the EMS 110, the MCU 140, the TCU 150, the HCU 160, and the TCS 170 may include at least one processor, a memory, and a network interface. The processor may be a semiconductor device that executes processing for instructions stored in the memory. The processor may be implemented as at least one of an application specific integrated circuit (ASIC), a digital signal processor (DSP), a programmable logic device (PLD), a field programmable gate array (FPGA), a central processing unit (CPU), a microcontroller, and/or a microprocessor. The memory may include various types of volatile or nonvolatile storage media. For example, the memory may include a storage medium (recording medium) such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a cache, and/or a removable disk.

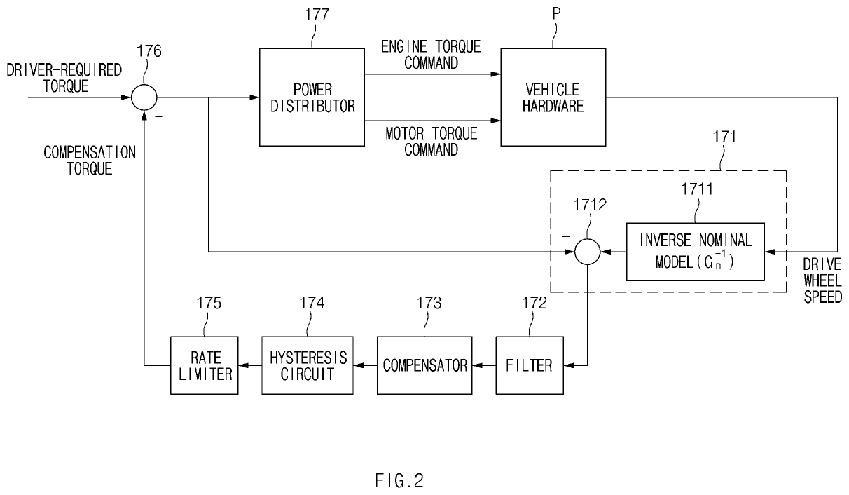

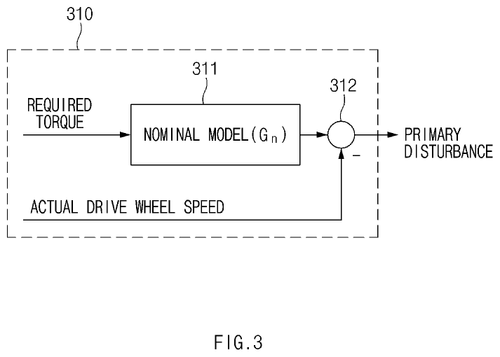

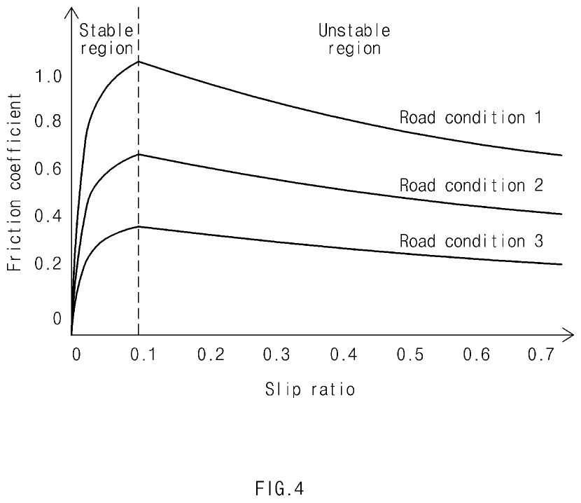

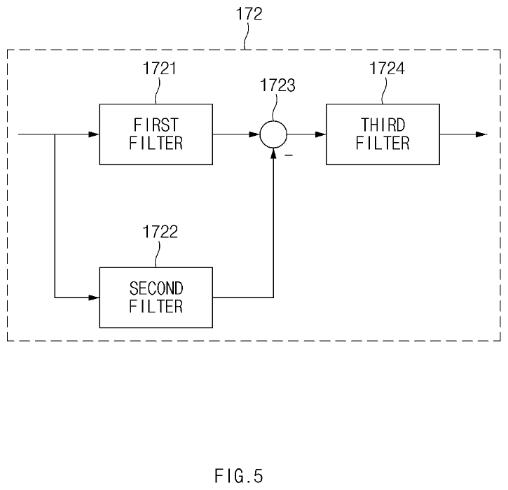

FIG. 2 is a functional block diagram illustrating a traction control system of an electrified vehicle according to an embodiment of the present disclosure. FIG. 3 is another example illustrating a configuration of a disturbance observer according to an embodiment of the present disclosure. FIG. 4 is a graph illustrating a traction force of a vehicle based on a slip ratio associated with the present disclosure. Further, FIG. 5 shows a configuration diagram of the filter illustrated in FIG. 2.

The traction control system (TCS) 170 of the electrified vehicle may include a processor that controls overall operation of the TCS 170 and a memory that stores a traction force control logic executed by the processor. Referring to FIG. 2, the traction force control logic may be composed of a disturbance observer 171, a filter 172, a compensator 173, a hysteresis circuit 174, a rate limiter 175, a calculator 176, and a power distributor 177.

The disturbance observer 171 may estimate (observe) a disturbance (hereinafter, referred to as a primary disturbance) that affects the vehicle's behavior during the vehicle acceleration based on a vehicle behavior model. The disturbance observer 171 may extract the primary disturbance based on a difference between the vehicle behavior estimated by the vehicle behavior model and an actual vehicle behavior. The disturbance observer 171 may include an inverse nominal model 1711 and a calculator 1712.

The inverse nominal model 1711, which is an inverse model of a nominal model of vehicle hardware (plant) P, may receive a drive wheel speed as an input to estimate a driving torque supplied to the drive wheels RR and RL (a supplied driving torque). In this connection, the drive wheel speed may be calculated from the revolution per minute of the drive wheel measured by the wheel speed sensor 130. The inverse nominal model 1711 may estimate a sum of the engine torque and the motor torque (the supplied driving torque) supplied to the drive wheels RR and RL of the vehicle using the drive wheel speed.

The calculator 1712 subtracts the driving torque required for driving the vehicle (required driving torque) from the supplied driving torque output from the inverse nominal model 1711 to calculate a difference between the supplied driving torque and the required driving torque. In this connection, the difference between the supplied driving torque and the required driving torque is recognized as the primary disturbance. The calculator 1712 may output the difference between the vehicle behavior estimated (predicted) by the inverse nominal model 1711 and the actual vehicle behavior as the primary disturbance.

In the present embodiment, the description has been achieved that the disturbance observer 171 uses the inverse nominal model 1711 as the vehicle behavior model as an example. However, the present disclosure may not be limited thereto, and may use the nominal model as the vehicle behavior model. For example, as shown in FIG. 3, a disturbance observer 310 may be implemented with a nominal model 311 and a calculator 312. The nominal model 311 may receive the required torque for driving the vehicle as an input, and estimate the drive wheel speed based on the input required torque. The calculator 312 may extract the primary disturbance by calculating the drive wheel speed estimated by the nominal model 311 and the actual drive wheel speed. The calculator 312 calculates a drive wheel speed difference by subtracting the actual drive wheel speed from the estimated drive wheel speed. In this connection, the calculated drive wheel speed difference may be recognized as the primary disturbance.

Next, a method for selecting a nominal model Gₙ(s) will be described.

Referring to FIG. 4, an absolute traction force peak varies depending on a road surface (a road condition), but a maximum traction force may be maintained when a slip ratio is within a stable region. However, when the slip ratio becomes great and moves to an unstable region, the maximum traction force is not able to be maintained. A slip ratio λ is able to be represented as following [Mathematical equation 1].

$$λ = \frac{{R}_{eff} ω - v}{{R}_{eff} ω} , {R}_{eff} ω > v \qquad [ Mathematical equation 1 ]$$

Here, R_{eff} is a tire dynamic diameter, ω is the wheel revolution per minute, and v is the vehicle speed.

An equivalent inertia moment Jeq in relation to slip ratio λ may be represented as [Mathematical equation].

J_{eq}=J_{whl}+mR_{eff}²(1−λ) [Mathematical equation 2]

Here, J_{whl} is an inertia moment of the wheel, and m is a weight of the vehicle.

When performing control by assuming that the slip ratio is ‘0’, an inertia moment Jₙ of the nominal model may be defined as [Mathematical equation 3].

Jₙ=J_{whl}+mR_{eff}² [Mathematical equation 3]

In the present embodiment, it has been described that the inertia moment Jₙ of the nominal model is selected based on the slip ratio. However, the present disclosure may not be limited thereto, and may select the inertia moment Jₙ of the nominal model based on acceleration data.

Based on [Mathematical equation 3], the nominal model Gₙ(s) may be defined as [Mathematical equation 4].

$${G}_{n} ( s ) = \frac{1}{{J}_{n} s} \qquad [ Mathematical equation 4 ]$$

In this connection, s is a complex frequency parameter.

The filter 172 filters (extracts) a disturbance in a specific frequency range (that is, a secondary disturbance or a final disturbance) predetermined from the primary disturbance extracted from the disturbance observer 171. The filter 172 may extract the second disturbance (the final disturbance) using at least one of a low pass filter (LPF), a high pass filter (HPF), or a band pass filter (BPF). The filter 172 may remove high frequency noise and filter only a low frequency disturbance using the low pass filter having a specific time constant. In addition, the filter 172 may extract the final disturbance by allowing only a high frequency disturbance equal to or above a specific frequency to pass using the high pass filter. In addition, the filter 172 may extract the final disturbance by allowing only a disturbance within the specific frequency range to pass using the band pass filter. Design of the band pass filter may be processed with a combination of LPFs.

Referring to FIG. 5, the filter 172 may include a first filter 1721, a second filter 1722, a calculator 1723, and a third filter 1724. The first filter 1721 filters a disturbance sensed when the wheel slip occurs. The first filter 1721 may extract the disturbance resulted from the wheel slip from the primary disturbance output from the disturbance observer 171. Because the disturbance sensed when the wheel slip occurs is a high frequency component, a disturbance passed through the first filter 1721 may contain the high frequency component. The second filter 1722 extracts a frequency component for sensing a travel resistance from the primary disturbance output from the disturbance observer 171. The second filter 1722 extracts disturbances resulted from a road surface inclination, a change in the weight of the vehicle, and/or other travel load variations. The disturbance output from the second filter 1722 contains a low frequency component. The calculator 1723 may extract a disturbance that causes the wheel slip by subtracting the low frequency component of the second filter 1722 from the high frequency component of the first filter 1721. The third filter 1724 removes a noise component from the disturbance output from the calculator 1723 and outputs the final disturbance.

The compensator 173 compensates for the driver-required-torque such that the secondary disturbance (that is, the final disturbance) output from the filter 172 becomes ‘0’. The compensator 173 calculates a compensation torque for canceling the final disturbance. The compensator 173 may set a gain when calculating the compensation torque. In this connection, the gain may be differentiated based on the road surface inclination. For example, the compensator 173 increases the gain as an inclination of an uphill road increases, thereby enabling fast compensation. The compensator 173 may be implemented in a proportional integral differential (PID) form. As the compensator 173, any other controller capable of solving a regulator problem that causes other disturbances to be ‘0’ is applicable.

The hysteresis circuit 174 controls a control sensitivity by adjusting a traction force control activation time point. The hysteresis circuit 174 may determine whether to compensate based on the compensation torque output from the compensator 173. The hysteresis circuit 174 determines to activate the torque compensation control when the compensation torque exceeds a first reference torque. The first reference torque is set such that whether the wheel slip has occurred is sensed and the control activation is not sensitive by the first reference torque. The hysteresis circuit 174 determines torque compensation control deactivation when the compensation torque is less than or equal to a second reference torque. The second reference torque may be set to ‘0’ normally.

The rate limiter 175, which is for preventing secondary shock and the like resulted from the traction force control, may limit a rate of change of the compensation torque. The rate limiter 175 may include a rate increase limiter and a rate decrease limiter to set the rate of change of the compensation torque based on increase and decrease of the compensation torque. Because of being required to control the wheel slip rapidly, the rate increase limiter may set a rate of change in the increase of the compensation torque to a single value in consideration of response characteristics of the motor 40. The rate decrease limiter may determine a rate of change in the decrease of the compensation torque based on the road surface inclination and/or the gear step, because shock (vibration) may be caused when an amount of the torque subtracted for the torque compensation is suddenly recovered. Typically, on a flat road, the weight is distributed in a balanced manner on front wheels FR and FL and rear wheels RR and RL, but not so on the uphill road, so that the higher the uphill road inclination, the lesser the rate of change in the decrease should be set. In addition, the rate of change in the decrease should be set differently based on the gear step.

The calculator 176 receives the driver-required-torque and the compensation torque as an input. The calculator 176 compensates for the driver-required-torque by subtracting the compensation torque from the driver-required-torque.

The power distributor 177 distributes the engine torque and the motor torque based on the required torque calculated by calculator 176. The power distributor 177 may preferentially distribute the driving torque to one of the engine 10 and the motor 40. For example, the power distributor 177 may preferentially control to generate the driving torque corresponding to the required torque using the motor 40, and control a remaining torque, which is obtained by subtracting the motor torque generated by the motor 40 from the required torque, to be generated by the engine 10 when the required torque is not able to be generated by the motor 40 alone. Once torque distribution based on the required torque is determined, the power distributor 177 may transmit the engine torque command and the motor torque command respectively to the EMS 110 and the MCU 140 to control the vehicle hardware P. In this connection, the HCU 160 may measure the revolution per minute of each wheel through each wheel speed sensor mounted on each wheel.

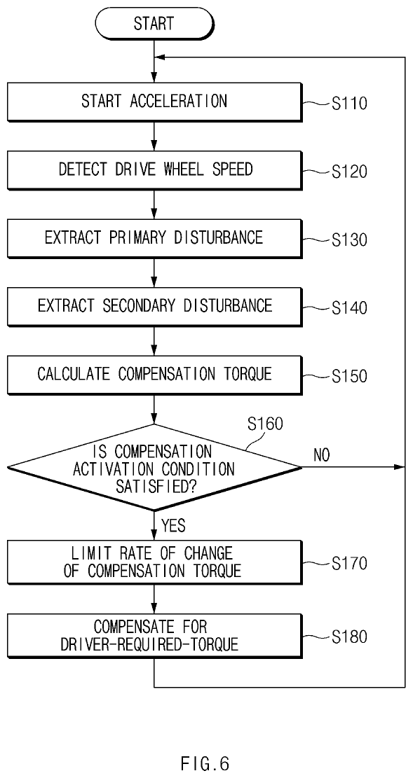

FIG. 6 is a flowchart illustrating a method for controlling a traction force of an electrified vehicle according to an embodiment of the present disclosure.

The traction control system (hereinafter, TCS) 170 of the electrified vehicle recognizes start of the acceleration of the vehicle (S110). The TCS 170 may recognize the acceleration situation through the HCU 160. The HCU 160 obtains the accelerator pedal position information through the accelerator pedal sensor 120 when the driver presses the accelerator pedal. The HCU 160 may calculate the driver-required-torque based on the obtained accelerator pedal position information and transmit the calculated driver-required-torque to the TCS 170. When receiving the driver-required-torque from the HCU 160, the TCS 170 recognizes a current situation as the acceleration situation. In the present embodiment, the description has been achieved that the TCS 170 receives the driver-required-torque from the HCU 160 as an example. However, the TCS 170 may not be limited thereto, and may directly obtain the driver-required-torque through the accelerator pedal sensor 120.

The TCS 170 detects the drive wheel speed using each wheel speed sensor mounted on each drive wheel when the vehicle starts to accelerate (S120). In this connection, the wheel speed sensor may count and output the revolution per minute of the drive wheel.

The TCS 170 estimates the vehicle behavior based on the drive wheel speed detected using the vehicle behavior model and extracts the primary disturbance by comparing the estimated vehicle behavior with the actual vehicle behavior (S130). The TCS 170 extracts an error between the vehicle behavior estimated using the inverse nominal model or the nominal model as the vehicle behavior model and the actual vehicle behavior as the primary disturbance. The TCS 170 extracts the primary disturbance by calculating the difference between the supplied driving torque based on the drive wheel speed using the inverse nominal model and the driving torque required for driving the vehicle (the required driving torque). In addition, the TCS 170 may estimate the drive wheel speed based on the required driving torque using the nominal model, calculate the difference between the estimated drive wheel speed and the actual drive wheel speed, and recognize the calculation result as the primary disturbance.

The TCS 170 extracts the secondary disturbance in the specific frequency range from the primary disturbance (S140). The TCS 170 may extract the secondary disturbance using at least one of the low pass filter, the high pass filter, or the band pass filter. In this connection, the specific frequency range may be set by a system designer in advance as a frequency domain in which an inertia force changes rapidly.

The TCS 170 calculates the compensation torque for canceling the secondary disturbance (S150). The TCS 170 may set the gain when calculating the compensation torque. In this connection, the gain may be differentiated based on the road surface inclination.

The TCS 170 determines whether the calculated compensation torque satisfies a compensation activation condition (S160). The TCS 170 determines to activate the torque compensation control when the compensation torque exceeds the first reference torque. The first reference torque is set such that whether the wheel slip has occurred is sensed and the control activation is not sensitive by the first reference torque. The TCS 170 determines to deactivate the torque compensation control when the compensation torque is less than or equal to the second reference torque. The second reference torque may be set to ‘0’ normally.

When the calculated compensation torque satisfies the compensation activation condition, the TCS 170 limits the rate of change of the compensation torque based on the increase or the decrease of the compensation torque (S170). The TCS 170 sets the rate of change in the increase of the compensation torque to the single value in consideration of the response characteristics of the motor 40. In addition, the TCS 170 may set the rate of change in the decrease of the compensation torque based on the road surface inclination and/or the gear step.

The TCS 170 compensates for the driver-required-torque based on the compensation torque and the rate of change of the compensation torque (S180). The TCS 170 compensates for the driver-required-torque by subtracting the compensation torque from the driver-required-torque. In this connection, the compensation torque is limited by the rate of change of the compensation torque. The TCS 170 may control the vehicle behavior based on the compensated required torque.

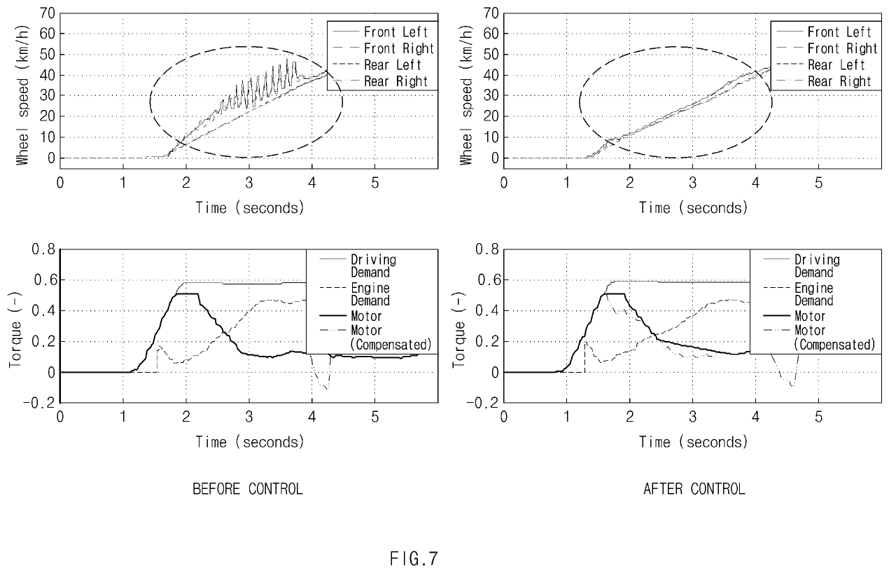

FIGS. 7 to 9 are views for describing a wheel slip control performance based on traction force control of an electrified vehicle according to an embodiment of the present disclosure.

Referring to FIG. 7, before applying the traction force control method suggested in the present specification, the slip occurred on the front wheels FR and FL when traveling on a flat road with high friction. However, after applying the traction force control method, the wheel speeds of all the wheels FR, FL, RR, and RL are similar to each other. That is, it may be seen that a wheel slip control performance is improved after the traction force control according to an embodiment of the present disclosure.

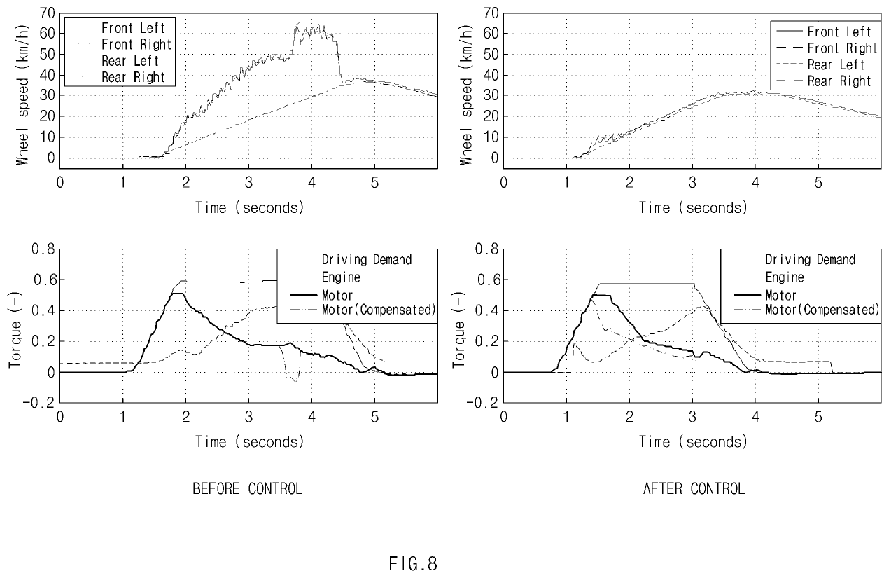

Referring to FIG. 8, in a situation of traveling on a low-friction road, before the torque compensation, a difference in the wheel speed between the front wheels FR and FL and the rear wheels RR and RL is large, so that a probability of slip occurrence is high. After the torque compensation, the difference in the wheel speed between the wheels is significantly reduced, so that the wheel slip control performance may be improved.

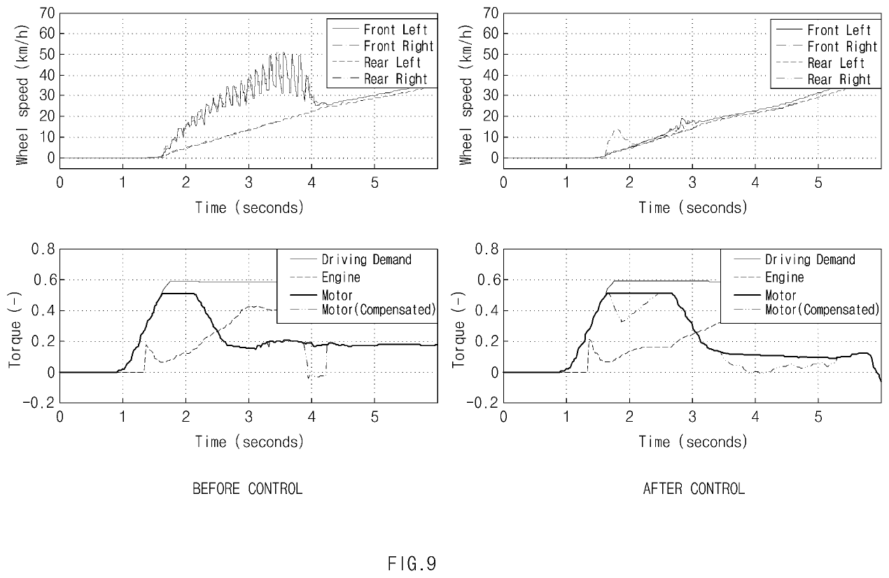

Referring to FIG. 9, in a situation of traveling an uphill road with an inclination of 20%, before the torque compensation, the slip occurs on the front wheels FR and FL. However, after applying the traction force control method, the difference in the wheel speed between the wheels FR, FL, RR, and RL does not occur, so that it may be seen that the wheel slip control performance is improved.

As such, according to the present embodiment, regardless of the travel situation, the wheel slip control performance may be improved, and additional sensors for sensing the vehicle speed are unnecessary, which is advantageous in terms of cost.

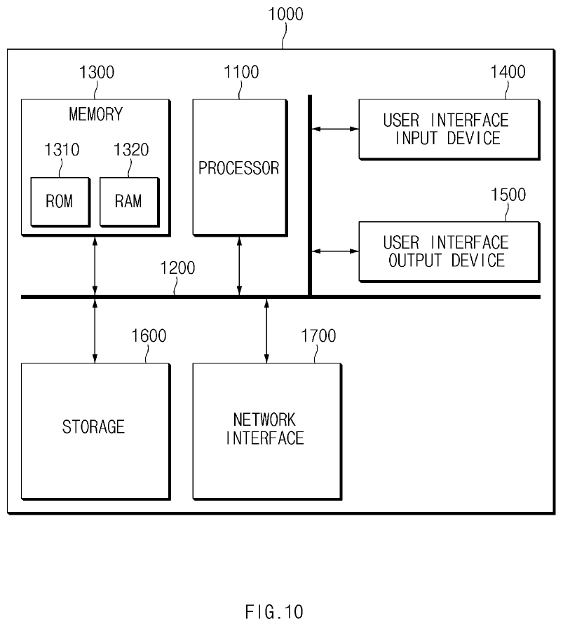

FIG. 10 illustrates a computing system in which a method for controlling a traction force of an electrified vehicle according to an embodiment of the present disclosure is implemented.

With reference to FIG. 10, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in a hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor 1100 and the storage medium may reside as individual components in the user terminal.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, the difference between the vehicle behavior estimated by the vehicle behavior model and the actual vehicle behavior is extracted as the disturbance, and the disturbance in the specific frequency range is extracted from the extracted disturbance, so that a control performance at a level equal to or greater than a certain level may be secured regardless of the travel situation.

In addition, according to the present disclosure, the wheel slip control activation time point is controlled and the rate of change of the compensation torque is limited based on the compensation torque, so that vibration, unnecessary energy consumption, and traction force loss resulted from the wheel slip may be reduced.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for controlling a traction force of a vehicle, the system comprising:
wheel speed sensors mounted on a plurality of drive wheels, respectively, of the vehicle to measure a drive wheel speed;
a disturbance observer for extracting a primacy disturbance by comparing an actual vehicle behavior based on a required torque with a vehicle behavior estimated based on the drive wheel speed using a vehicle behavior model when the vehicle is accelerating;
a filter for extracting a secondary disturbance in a preset frequency range from the primary disturbance;
a compensator for calculating a compensation torque for cancelling the secondary disturbance;
a hysteresis circuit for determining whether to compensate for the required torque based on the compensation torque; and
a calculator for calculating a compensated required torque using the required torque and the compensation torque.

2. The system of claim 1, wherein a nominal model or an inverse nominal model is used as the vehicle behavior model.

3. The system of claim 1, wherein the filter includes at least one of a low pass filter, a high pass filter, or a band pass filter.

4. The system of claim 1, wherein the compensator sets a gain based on a road surface inclination when calculating the compensation torque.

5. The system of claim 1, wherein the hysteresis circuit determines to activate torque compensation control when the compensation torque exceeds a first reference torque.

6. The system of claim 1, wherein the hysteresis circuit determines to deactivate torque compensation control when the compensation torque is less than or equal to a second reference torque.

7. The system of claim 1, further comprising:
a rate limiter for limiting a rate of change of the compensation torque when compensating for the required torque.

8. The system of claim 7, wherein the rate limiter sets a rate of change in increase of the compensation torque to a single value in consideration of response characteristics of a motor.

9. The system of claim 7, wherein the rate limiter sets a rate of change in decrease of the compensation torque based on at least one of a road surface inclination or a gear step.

10. The system of claim 1, further comprising:
a power distributor for controlling the vehicle behavior by distributing the compensated required torque to a motor and an engine,
wherein the power distributor preferentially distributes the compensated required torque to the motor.

11. A method for controlling a traction force of a vehicle, the method comprising:
detecting, by drive wheel sensors, a drive wheel speed based on a required torque when the vehicle is accelerating;
extracting, by a disturbance observer, a primary disturbance by comparing a vehicle behavior estimated based on the drive wheel speed with an actual vehicle behavior based on the required torque;
extracting, by a filter, a secondary disturbance in a preset frequency range from the primary disturbance;
calculating, by a compensator, a compensation torque for cancelling the secondary disturbance;
determining, by a hysteresis circuit, whether to compensate for the required torque based on the compensation torque; and
compensating, by a calculator, for the required torque by reflecting the compensation torque.

12. The method of claim 11, wherein extracting the primary disturbance includes:
extracting the primary disturbance using a nominal model or an inverse nominal model as the vehicle behavior model.

13. The method of claim 11, wherein extracting the secondary disturbance includes:
filtering the secondary disturbance from the primary disturbance using at least one of a low pass filter, a high pass filter, or a band pass filter.

14. The method of claim 11, wherein calculating the compensation torque includes:
setting a gain based on a road surface inclination when calculating the compensation torque.

15. The method of claim 11, wherein determining whether to compensate for the required torque includes:
determining to activate torque compensation control when the compensation torque exceeds a first reference torque.

16. The method of claim 11, wherein determining whether to compensate for the required torque includes:
determining to deactivate torque compensation control when the compensation torque is less than or equal to a second reference torque.

17. The method of claim 11, further comprising:
limiting a rate of change of the compensation torque when compensating for the required torque.

18. The method of claim 17, wherein limiting the rate of change of the compensation torque includes:
setting a rate of change in increase of the compensation torque to a single value in consideration of response characteristics of a motor.

19. The method of claim 17, wherein limiting the rate of change of the compensation torque includes:
setting a rate of change in decrease of the compensation torque based on at least one of a road surface inclination or a gear step.

20. The method of claim 11, further comprising:
controlling the vehicle behavior by distributing the compensated required torque to a motor and an engine,
wherein the compensated required torque is preferentially distributed to the motor.
